(19) United States
(12) Patent Application Publication
(10) Pub. No.: US 2009/0130620 A1
(43) Pub. Date: May 21, 2009

(54) Bone supported palatal expansion appliance

(76) Inventors: Mohamadreza Yazdi, Santa Monica, CA (US); Robert J. Relle, Calabasas, CA (US)

Correspondence Address: WALTER A. RODGERS;RODGERS & RODGERS, 6100 LAKE FORREST DRIVE, SUITE 340, ATLANTA, GA, 30328, US

(21) Appl. No.: 12/313,113

(22) Filed: Nov. 17, 2008

Related U.S. Application Data
(60) Provisional application No. 61/003,393, filed on Nov. 19, 2007.

(51) Int. Cl. A61C 7/06

(52) U.S. Cl. 433/7

(57) ABSTRACT

The appliance comprises a machined or cast interface that secures the appliance to bone by means of an appliance connection and a bone connection. The connection is a cylindrical sleeve into which each arm of the expansion appliance is inserted. This connection is maintained by crimping the sleeve over the easily modified activating rods of the expansion appliance, thus preventing separation or rotation of the device. The bone connection is a threaded hole in the connector sleeve into which a self-drilling screw is inserted. The screw engages the bone in a manner determined by the design and location of the expansion appliance.

The benefits of 35 U.S.C. 119 are claimed of provisional patent application 61/003,393 filed Nov. 19, 2007.

### BACKGROUND OF THE INVENTION

Transverse maxillary deficiency affects a significant number of patients who seek orthodontic treatment. It is estimated that transverse maxillary deficiency is present in as many as 18% of children with deciduous and mixed dentitions who seek orthodontic consultation. Orthopedic expansion of the maxilla, also called rapid palatal expansion (RPE), is a commonly accepted practice in young patients. The technique was first introduced by Angel in 1860 and popularized by Haas in the 1960s. The effectiveness of this procedure in patients prior to skeletal maturity has been repeatedly validated.

Besides tooth-anchored devices, bone anchored expansion devices offer promise in circumventing problems found in conventional devices. With bone distracters, expansion of the maxilla is purely orthopedic, without the dental side effects, because the expansion force is applied directly to bone. Therefore, there is no relapse and thus is by far the method of choice. The reason it is not widely accepted by clinicians; however, is that there is not a user-friendly appliance available. One reason is that these appliances require additional surgical procedures to fit and secure devices to the maxilla. Another reason is that they are relatively costly compared to traditional tooth-borne maxillary expansion devices.

Attempts to orthopedically expand the maxilla in skeletally mature patients can cause undesired lateral tipping and extrusion of posterior teeth, buccal root resorption, gingival recession, fenestration of the buccal cortex and instability and ultimately failure of treatment. Because of these complications, most skeletally mature patients are treated by means of surgically assisted rapid palatal expansion (SARPE) when significant transverse correction is required. The technique is analogous to distraction osteogenesis, except that traditional tooth borne expansion devices have been used most commonly. Despite the relative effectiveness of SARPE in widening the maxilla, not all of the aforementioned deleterious effects on the teeth, gingiva and bone can be avoided. This is due to the fact that the expansion forces are still being applied in the same manner as RPE when tooth borne appliances are used.

A number of bone-borne devices of varying construction have been used in order to prevent potential problems. One such device known as the Rotterdam distracter has proven effective in this regard. This device employs a “car jack” style distractor that is self-retained on palatal bone by six nails on each side of the distractor that engage bone during initial activation of the device. Another design known as the Magdeberg palatal distractor serves a similar purpose. This distractor is secured to the palate by means of drilled holes into which bone screws are inserted. Several variations of these devices have been described in the scientific literature, and all of them have reported effectiveness in producing true skeletal expansion. These devices are engineered similar to other commercially available craniofacial distraction osteogenesis devices, and therefore share limitations, including expense, complicated construction and somewhat limited customization.

### BRIEF SUMMARY OF THE INVENTION

A bone distracter which is easy to adapt and customize by the clinician and is adaptable to any palatal morphology by the clinician. This invention utilizes a modified expansion screw device with two closely approximated parallel activation rods that are both textured along their length and nonround in cross section. Four cylindrical connector sleeves are inserted on to the ends of each of the activation rods and secured thereto by means of crimpable connector sleeves disposed on the activation rods of the expansion device. In turn, the apertures at the distal end of the connector sleeves include threads that match those on the head of the anchor screws. The screws engage the patient's bone in a manner determined by the location of the expansion appliance.

### DESCRIPTION OF THE SEVERAL VIEWS OF THE DRAWINGS

In the drawings:

FIG. 1 is a perspective view of the expansion device according to this invention;

FIGS. 2A-2C are perspective views of variations of the connector sleeve;

FIG. 3 is a perspective view of the anchor screw;

FIG. 4F shows variations in the outer surfaces of the activation rods;

FIG. 5 is a perspective view of the connector sleeve and connection sleeve spacer; and

FIG. 6 is a plan view showing the expansion device according to this invention disposed in a patient's palate.

### DETAILED DESCRIPTION OF THE INVENTION

In the drawings and with particular reference to FIG. 1, the basic elements of the distracter, according to this invention, are shown in which the numerals 1 and 2 designate spaced base sections which are interconnected by means of expansion screw 3. Stabilizing rods 4 and 5 are disposed on opposite sides of expansion screw 3 and are parallel thereto with the ends thereof disposed within the respective base sections 1 and 2. To complete the basic elements of the expander as shown in FIG. 1, activation rods 6 and 7 are attached to base members 1 and 2, respectively, by means of conventional clamps 8 and 9 which are attached to base sections 1 and 2, respectively, by any suitable means such as screws and the like. Activation rods 6 and 7 are positioned as close together as possible in order to accommodate narrow palates.

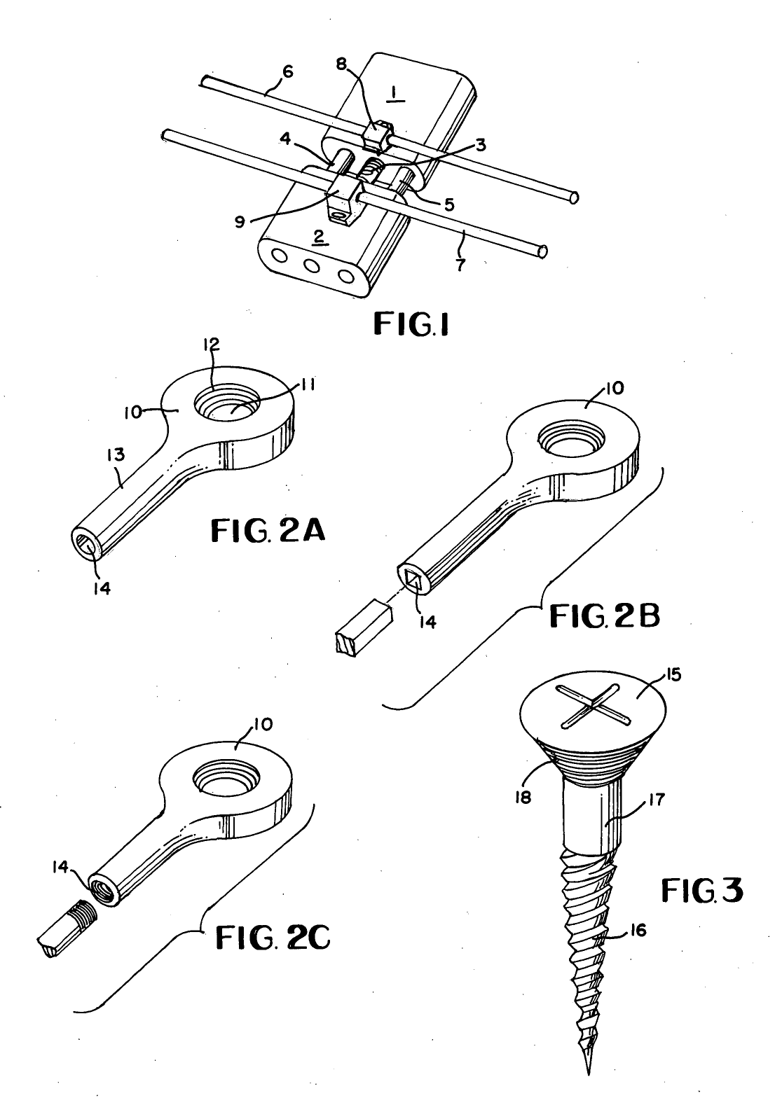

In FIG. 2A, connector sleeve 10 is shown, according to this invention, and includes aperture 11 with threads 12 disposed around the periphery thereof. Also, connector sleeve 10 includes crimpable sleeve portion 13 with bore 14 formed therein. In FIGS. 2B and 2C, modifications of connector sleeve 10 are depicted in which, as shown in FIG. 2B, bore 14 is of a square configuration in order to receive a quadrilateral activation rod 6 or 7 and, in FIG. 2C, bore 14 is threaded in order to receive the correspondingly threaded end of an activation rod 6 or 7.

In FIG. 3, anchor screw 15 is shown and includes self-tapping threads 16. Threads 16 are self-tapping in order to reduce damage to the dental roots. Collar 17 is disposed above threads 16 and collar 17 is smooth in order to create an optimal interface with the patient's palatal soft tissue through which anchor screw 15 is inserted. By this means, the tendency for plaque and debris to adhere to the screw surface is reduced which thereby reduces tissue inflammation. Threads 18 disposed on the head of anchor screw 15 match exactly threads 12 of connector sleeve 10. Once anchor screw 15 is tightened, any rotation or tipping of the expander is prevented.

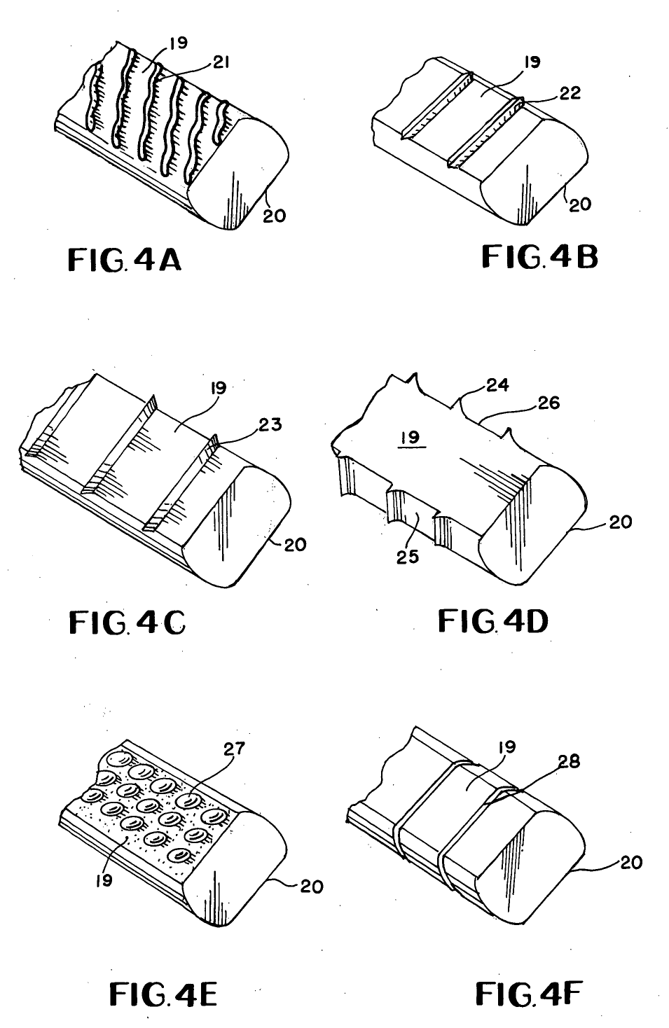

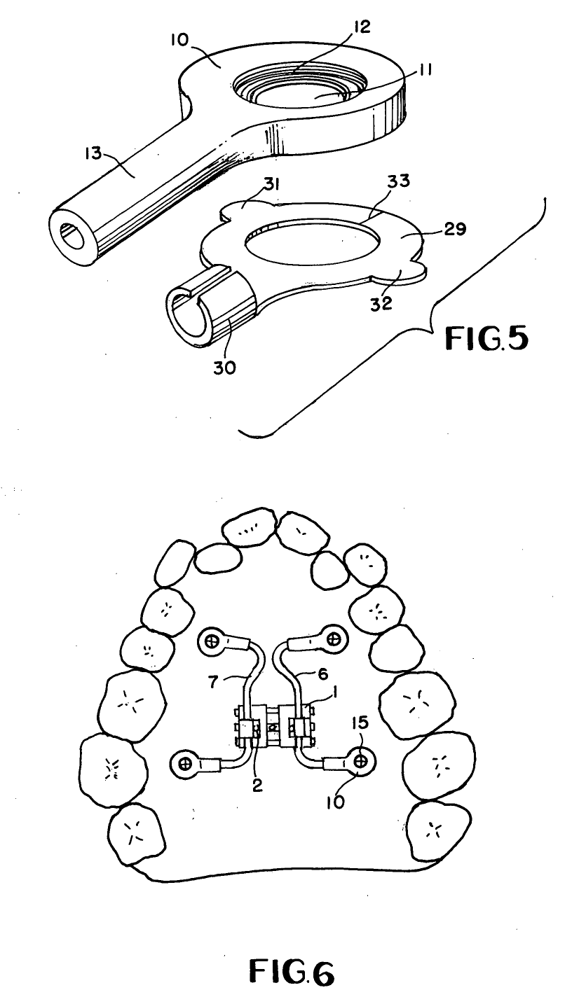

In FIGS. 4A-4F, various configurations of nonround activation rods 6 and 7 are shown. Each activation rod 6 and 7 includes opposed flat surfaces 19 and 20. In FIG. 4A, irregular raised ribs 21 are formed on flat surfaces 19 and 20 and indentations 22 are formed on surfaces 19 and 20 in FIG. 4B. In FIG. 4C, flange-like projections 23 are formed on surfaces 19 and 20 and, in FIG. 4D, flange-like projections 24 are formed on the rounded sides 25 and 26 of activation rods 6 and 7. As viewed in FIG. 4E, raised nodules 27 are formed on surfaces 19 and 20 and bands 28 extend around the ends of activation rods 6 and 7, as shown in FIG. 4F.

In FIG. 5, an elastomeric spacer, according to this invention, is shown and includes apertured ring portion 29 disposed below connector sleeve 10 and further includes slotted collar 30 and oppositely in disposed tabs 21 and 32. Cut line 33 is formed in ring portion 29.

In practice, and according to this invention, first a palatal impression is taken of the patient and activation rods 6 and 7 are sized to fit into the particular patient's palate with any extra length cut off. Following this, connector sleeves 10 are respectively placed on the ends of activation rods 6 and 7 and securely attached in position by means of a conventional crimping tool. Since the ends of activation rods 6 and 7 are nonround with the selected irregular structural projections and indentations formed on the ends of activation rods 6 and 7, connector sleeves 10 are securely affixed in place. Then slotted collars 30 extending from ring portions 29 are separated and positioned around sleeve portions 13 of connector sleeves 10. The entire device is then positioned onto the patient's impression cast such that activation rods are 6 and 7 are bent into configurations which are optimal for the particular patient's anatomy. Markings are then made through apertures 11 of connector sleeves 10. These markings are then duplicated on the mucosa of the patient's palate and the device is placed in the patient's mouth using the marks as a guide. Topical anesthetics are then used to anesthetize the mucosa at the position of each marking and then anchor screws 15 are screwed into the patient's palate through apertures 11. The expander is activated several turns by means of a typical key to turn expansion screw 3 to ensure it is operating properly and then returned to its fully closed position. Following this, base members 1 and 2 are moved as treatment dictates.

After the distracter is in position and anchor screws 15 fully screwed into the patient's bone, tabs 31 and 32 of each ring portion 29 are pulled apart by means of tweezers which causes ring portion 29 to separate along cut line 33. The entire spacer is then pulled away from connector sleeve 10 whereby slotted collar 30 is disengaged from sleeve portion 13 of connector sleeve 10.

By this means, an appropriate space is maintained between each connector sleeve 10 and the surrounding tissue which eliminates tissue inflammation and potential pressure necrosis. In FIG. 6, the distracter, according to this invention, is shown in a treatment position in a patient's palate.

Therefore, by this invention, a simple and inexpensive expansion device is achieved which is attached only to a patient's bone without the problems of dental expansion and alveolar bending. This device is more hygienic than a tooth supported expansion appliance and orthodontic treatment may commence during the palatal expansion.

1. A bone expansion appliance comprising a pair of spaced base sections, an expansion screw interconnecting said base sections, a pair of activation rods disposed in close proximity and being attached respectively to said base sections, connector sleeves secured to the ends of said activation rods, and threaded apertures formed in said connector sleeves.

2. An appliance according to claim 1 wherein an anchor screw comprising a first set of self-tapping threads, a smooth collar disposed above said first set of screws, and a second set of threads disposed above said smooth collar and being adapted to interlock with said threaded aperture.

3. An appliance according to claim 1 wherein said activation rods comprise a pair of oppositely disposed flat surfaces and wherein the surfaces between said flat surfaces are rounded.

4. An appliance according to claim 3 wherein structural irregularities are formed on said flat surfaces.

5. An appliance according to claim 1 wherein said connector sleeve comprises sleeve portions extending outwardly from said threaded apertures.

6. An appliance according to claim 5 wherein said sleeve portions are crimpable.

7. An appliance according to claim 6 wherein a spacer is disposed adjacent and in face contacting relation with one of said connector sleeves.

8. An appliance according to claim 7 wherein said spacer is made of elastomeric material.

9. An appliance according to claim 7 wherein said spacer comprises an apertured ring portion, a cut line formed in said ring, and a slotted collar extending from said ring.

10. An appliance according to claim 9 wherein a pair of oppositely disposed tabs extending outwardly from said ring portion.
